(19) United States
(12) Patent Application Publication
(10) Pub. No.: US 2013/0333101 A1
(43) Pub. Date: Dec. 19, 2013

(54) TEXTILE BICOUCHE DE PROTECTION CONTRE LA CHALEUR ET VETEMENT DE PROTECTION CONTRE LE FEU ET/OU LA CHALEUR METTANT EN OEUVRE CE TEXTILE

(71) Applicant: Sofileta, (US)

(72) Inventors: Benoit BOURET, Lyon (FR); Denis COULAUX, Caluire (FR)

(73) Assignee: Sofileta, Bourgoin-Jallieu (FR)

(21) Appl. No.: 13/888,606

(22) Filed: May 7, 2013

(30) Foreign Application Priority Data
May 9, 2012 (FR) 12.54193

(51) Int. Cl. A62B 17/00; B32B 5/26; B32B 7/14; B32B 5/02

(52) U.S. Cl. CPC A62B 17/003; B32B 5/026; B32B 5/022; B32B 5/26; B32B 7/14
USPC 2/455; 442/308; 442/334; 428/197; 428/196

(57) ABSTRACT

This heat-protective bilayer textile is formed of the assembly of
an inner layer, formed of a grid, of knitted fabric, or of a nonwoven made of poly-para-phenylene terephtalamide (para-aramid) and,
an outer layer, formed of a fabric or of a knitted fabric made with poly-meta-phenylene isophtalamide (meta-aramid) threads, said thread being formed of a fiber yarn having a length distribution ranging between 40 and 200 millimeters, and having a minimum thread count of 40.

### FIELD OF THE INVENTION

The invention relates to textiles having a good resistance to heat and to fire. Such textiles are more specifically intended to be used in the context of the manufacturing of clothing of protection against flames, electric arcs, and generally any heat source. Such clothing is thus more specifically intended for firemen, military personnel, and people in industry exposed to risks of exposure to flames.

### BACKGROUND

Since the developments initiated in relation with the manufacturing of textiles capable of resisting against flames, fibers said to be heat-stable, that is, fire-resistant, are known. Such fibers in particular comprise aramids, and especially meta-aramid, better known under trademark NOMEX®, and para-aramid, better known under trademark KEVLAR®. These two types of synthetic fibers have a high performance, especially in terms of heat-stability, but also in terms of mechanical resistance.

Meta-aramid is preferred, for certain applications, due to its better dyeing affinity and its greater flexibility than para-aramid. A mixture of such fibers, such as for example, that sold by DUPONT DE NEMOURS under reference NOMEX® type 455, formed of 95% of meta-aramid and 5% of para-aramid, or that sold by the same company under reference Nomex ® type N302, formed of 93% of meta aramid, 5% of para-aramid, and 2% of antistatic fibers, has actually also be provided. Despite their commercial success, such mixtures are not fully satisfactory for a number of points, and especially that regarding fiber transformation and preparation states, especially during the textile spinning, weaving, dyeing, and care.

Further, they have a relatively low resistance to abrasion. Moreover, this type of product has a pilling tendency, that is, it forms small fluffy balls at its surface, mainly due to friction.

To fight such phenomena, a sufficiently tight fabric density must then be provided to limit the relative displacement of threads, and as a consequence, the shearing effect of fibers when the fabric is submitted to friction. Thereby, the permeability to air, and thus the wearing comfort, is decreased.

Another difficulty to take into account is the capacity of the textile resulting from the use of such a mixture to resist to the opening of holes when it is submitted to fire, that is, the “break open” resistance (ISO standard 15025). ISO standard 15025 defines the “break open” phenomenon or the forming of a hole as the breaking with a continuous perimeter and of at least 5 mm in any dimension, caused by the melting, the glowing, or the ignition of the material.

The present invention aims at providing a textile doing away with these different disadvantages and additionally optimizing the user's comfort.

### SUMMARY OF THE INVENTION

For this purpose, the invention provides a heat-protective bilayer textile. According to the invention, the bilayer textile is formed of the assembly of:
an inner layer, formed of a grid, of knitted fabric, or of a nonwoven made of polypara-phenylene terephtalamide (para-aramid) and,
an outer layer, formed of a fabric or of a knitted fabric made with poly-metaphenylene isophtalamide (meta-aramid) threads, said thread being formed of a fiber yarn having a length distribution ranging between 40 and 200 millimeters, and by a minimum thread count of 40.

According to a feature of the invention, and regarding the outer layer, the strand, forming the meta-aramid thread, is obtained by a preparation method known as stretch breaking. This method comprises breaking a precursor cable of continuous filaments by controlled stretching and breaking, especially between cylinders rotating at different speeds. This method enables to arrange and to align the crystalline areas of the polymer, until the most fragile chemical bonds are broken.

Thereby, a roving with fiber lengths having a regular distribution, typically between 40 and 200 millimeters, each individual fiber of which contains a crystalline orientation optimized lengthwise, is obtained.

As a result, the obtained meta-aramid thread has a high tenacity, optimizing the mechanical resistance of the resulting textile or fabric. Further, this tenacity also enables to optimize the resistance to abrasion.

At the same time, the inner layer made of para-aramid first enables to optimize the resistance to the “break-open” phenomenon. Para-aramid is considered to have a better fire resistance, but is however well known to be less abrasion-resistant and to have a lower resistance to ultraviolet rays.

At the same time, the high-tenacity meta-aramid used for the external layer and obtained according to the previously-described method is light and its mechanical properties and pilling resistance are optimized. The association of such a material with a fabric, a nonwoven, or a knitted fabric made of para-aramid enables to solve this difficulty.

For that matter, the grid, the knitted fabric, or even the nonwoven made of para-aramid have breathing properties, which enable to promote the evacuation of sweat when the concerned textile is intended to form a piece of clothing.

The two layers are advantageously assembled by gluing, either by spot hot melt lamination, or by a coating process.

According to a variation, this assembly may also be formed by quilting (by sewing).

This assembly enables to keep the advantages of each of the fibers of each of the surfaces.

The invention also relates to fire- and/or heat-protective clothing using such a bilayer textile.

### DETAILED DESCRIPTION

As already mentioned, the invention relates to a bilayer textile, more specifically intended for the making of clothing submitted to fire and heat, and thus generally intended for firemen, soldiers, or even workers in industries submitted to fire or heat sources.

The outer surface, conventionally most distant from the user's body, is essentially formed of meta-aramid (poly meta-phenylene-isophtalamide). This surface is formed of a fabric of a knitted fabric, having its thread formed of a fiber yarn, the length distribution of said fibers ranging between 40 and 200 millimeters, and the minimum thread count is 40. Antistatic fibers, such as for example formed of a conductive core containing carbon fibers covered with matrixes containing polyamide 6 or polyamide 6.6 may advantageously be integrated in the context of the forming of the thread of antistatic fibers.

As already mentioned, the strand is obtained by another preparation method known as stretch breaking, intended to arrange and to align the polymer crystalline areas until the most fragile chemical bonds are broken, A thread having mechanical properties much greater than those obtained, for example, by other conventional thread-forming methods is thus obtained.

The broken fiber yarn is thinned and frayed on a long-fiber ring spinning system. The thread provided by this spinning has a very good homogeneity, providing the textile using this thread with a better resistance to pilling and to abrasion.

With such a basic material (meta-aramid), in addition to the thread-forming method, the linear mass density typically ranges between 85 and 220 dtex, and has a tenacity when the thread is made of 100% of meta-aramid of 30 cN/tex. This tenacity value is to be compared with that of the initial precursor, in the case in point 36 cN/tex.

By means of such a thread, the outer layer is thus formed by weaving or knitting, This outer layer thus has, due to the nature of the basic material, good heat-resistance properties, in addition to, due to a strand of high tenacity, a better resistance to abrasion or to pilling.

According to the invention, the inner layer, that is, that closest to the user when the textile of the invention is intended to form a piece of clothing, is made of para-aramid. Typically, it is used in the form of a grid having a density ranging between 10 and 80 g/m². Indeed, if the grid density is smaller than 10 g/m², no major technical effect can be observed. However, if this density is greater than 80 g/m², a product too expensive in terms of manufacturing is obtained.

The assembly of the two layers is advantageously performed by spot gluing (using a hot melt glue), and typically a glue made of fire-proof polyurethane. The density of glue or of any element enabling to assemble the two layers does not exceed 30 g/m².

According to a variation, the assembly could still be provided by gluing, but by coating.

According to still another variation, the two layers are assembled by quilting, that is, by sewing at regular intervals, lengthwise as well as widthwise.

The textile thus formed enables to keep the properties of each of the two layers. For that matter, the inner para-aramid layer enables to perform a shielding function, and thus to further optimize the textile resistance to heat and to fire.

At the same time, the para-aramid, especially present in the form of a grid, enables to promote the evacuation of moisture, and especially sweat and perspiration. In other words, it enables to perform a moisture management function.

Finally, the use of an inner layer, for example, made of para-aramid, enables to more efficiently satisfy the standard relative to the break-open phenomenon.

1. A heat-protective bilayer textile, formed of the assembly of:
an inner layer, formed of a grid, of knitted fabric, or of a nonwoven made of poly-para-phenylene terephtalamide (para-aramid) and,
an outer layer, formed of a fabric or of a knitted fabric made with poly-meta-phenylene isophtalamide (meta-aramid) threads, said thread being formed of a fiber yarn having a length distribution ranging between 40 and 200 millimeters, and having a minimum thread count of 40.

2. The heat-protective bilayer textile of claim 1, wherein the strand forming the meta-aramid thread is obtained by a preparation method known as stretch breaking.

3. The heat-protective bilayer textile of claim 1, wherein the two layers are assembled by spot gluing (hot melt), or even by coating.

4. The heat-protective bilayer textile of claim 1, wherein the two layers are advantageously assembled by quilting.

5. Fire- and/or heat-protective clothing comprising the bilayer textile of claim 1.
